(19) United States
(12) Patent Application Publication
(10) Pub. No.: US 2023/0416050 A1
(43) Pub. Date: Dec. 28, 2023

(54) ARRANGEMENT FOR CONDITION MONITORING OF A ROPE OF A HOISTING APPARATUS

(71) Applicant: Kone Corporation, Helsinki (FI)

(72) Inventors: Petteri VALJUS, Helsinki (FI); Aleksi NAREIKKO, Helsinki (FI); Telmo SANTOS, Caparica (PT); Miguel MACHADO, Caparica (PT)

(73) Assignee: Kone Corporation, Helsinki (FI)

(21) Appl. No.: 18/462,075

(22) Filed: Sep. 6, 2023

Related U.S. Application Data
(63) Continuation of application No. PCT/EP21/55913, filed on Mar. 9, 2021.

(51) Int. Cl. B66B 7/12; G01N 27/90

(52) U.S. Cl. CPC B66B 7/123; G01N 27/90; B66B 7/1223

(57) ABSTRACT

The invention relates to an arrangement for condition monitoring of a rope of a hoisting apparatus. The arrangement for condition monitoring of a rope of a hoisting apparatus according to the present invention comprises one or more eddy current test units placed near said rope for generating a time-varying magnetic field, and for detecting a secondary magnetic field being generated by eddy currents in said rope as eddy current detection data, and an on-line monitoring unit receiving and utilizing said eddy current detection data for on-line condition monitoring of said rope, wherein an at least one eddy current test unit comprises: one or more printed circuit boards placed near said rope and arranged in a perpendicular direction in relation to the plane formed by adjacent load bearing members of said rope and parallel to each other, and arranged in a parallel direction or in a direction turned 20 degrees or less from the parallel direction in relation to the length of said rope, wherein at least one printed circuit board each comprises one or more eddy current inspection probes, each of said one or more eddy current inspection probes comprising two excitation coils and/or sensing coils near said rope.

### CROSS-REFERENCE TO RELATED APPLICATION

This application is a continuation of PCT International Application No. PCT/EP2021/055913 which has an International filing date of Mar. 9, 2021, the entire contents of which are incorporated herein by reference.

### FIELD OF THE INVENTION

The invention relates to an arrangement for condition monitoring of a rope of a hoisting apparatus. Said hoisting apparatus is preferably an elevator for transporting passengers and/or goods.

### BACKGROUND OF THE INVENTION

An elevator typically comprises an elevator car and a counterweight, which are vertically movable in a hoistway. These elevator units are interconnected to each other by a hoisting roping. The hoisting roping is normally arranged to suspend the elevator units on opposite sides of a drive wheel. For providing force for moving the suspension roping, and thereby also for the elevator units, the elevator comprises a motor for rotating the drive wheel engaging the hoisting roping. The motor is automatically controlled by an elevator control system, whereby the elevator is suitable for automatically serving passengers.

In elevators, the hoisting roping comprises at least one but typically several elevator ropes passing alongside each other. The conventional elevators have steel ropes, but some elevators have ropes that are belt-shaped, i.e. their width is substantially greater than the thickness. As with any other kind of rope, position of the belt-shaped ropes relative to the drive wheel around which it passes (in the axial direction of the drive wheel) so that none of the ropes drifts in said axial direction away from the circumferential surface area of the drive wheel against which the rope in question is intended to rest.

Typically, in prior art, position of ropes in said axial direction has been controlled by providing the drive wheel and the rope engaging the drive wheel with a ribbed or toothed shapes complementary for each other, whereby movement of the rope in said axial direction is blocked by mechanical shape-locking. One alternative way to control position of the belt-shaped ropes in said axial direction is to shape the circumferential surface areas of the drive wheel cambered (also known as crowned). Each cambered circumferential surface area has a convex shape against the peak of which the rope rests. The cambered shape tends to keep the belt-shaped rope passing around it to be positioned such that it rests against the peak thereof, thereby resisting displacement of the rope far away from the point of the peak.

Ropes of a hoisting apparatus typically include one or several load bearing members that are elongated in the longitudinal direction of the rope, each load bearing member forming a structure that continues unbroken throughout the length of the rope. Load bearing members are the members of the rope which are able to bear together the load exerted on the rope in its longitudinal direction. The load, such as a weight suspended by the rope, causes tension on the load bearing member in the longitudinal direction of the rope, which tension can be transmitted by the load bearing member in question all the way from one end of the rope to the other end of the rope. Ropes may further comprise non-bearing components, such as an elastic coating, which cannot transmit tension in the above described way.

In prior art, such ropes exist where the load bearing members are embedded in non-conducting coating, such as polymer coating, forming the surface of the rope and extending between adjacent load bearing members thereby isolating them from each other both mechanically and electrically.

It is very important to monitor the condition of the ropes of the hoisting apparatus. A local defect in a rope may affect the breaking strength of the rope, or it may cause the rope to move away from crowning of the drive wheel. For facilitating awareness of condition of the ropes, and thereby for improving safety of the hoisting apparatus, monitoring of the condition of the load bearing members has been proposed.

A visual inspection for monitoring the condition of the ropes of the hoisting apparatus is tedious, time consuming and prone to fail. Typically, in a visual inspection a rope is monitored only in a certain number of locations, not throughout the entire rope. Furthermore, a visual inspection does not allow the identification of internal or sub-surface defects. The visual inspection of the internal tensile elements is generally regarded as impossible and hence the need arises for non-visual inspection. The condition monitoring has been proposed in prior art to be arranged by monitoring electrical parameters of the load bearing members.

One known solution for checking the condition of the tensile elements is the resistance-based inspection, which is based on a measure of the electrical resistance of the tensile elements. A change in the electrical resistance or a deviation from an expected value is interpreted as a damage of the tensile elements. There are some drawbacks to this solution. It has been found, however, that non negligible damages may nevertheless result in small variations of the electrical resistance of common tensile elements such as steel cords. Consequently, the sensitivity of the resistance-based inspection is not satisfactory.

One prior art solution for condition monitoring of a rope is to place an electrically conductive member within the rope. The status of the conductive member may be tested by applying an electrical current to the member. If damage occurs to an extent great enough to break the conductive member, the electrical circuit is broken. There are some drawbacks to this solution. In this solution there is no qualitative information to indicate if the rope is degrading during use as the first indication is provided by the broken conductive member. Furthermore, the solution provides no information on the location of the damage along the length of the rope.

In addition to a damage or defect in the rope, slackness and misalignment of the rope might cause serious problems in use of the hoisting apparatus. A drawback of the known elevators has been that moving of a rope in the axial direction outside its intended course, and further development of the problem into even more hazardous state have not been prevented in an adequately reliable manner. This has been difficult especially with elevators where said mechanical shape-locking between the drive wheel and the rope engaging the drive wheel has been inadequately reliable or unavailable for some reason such as due to preference to utilize cambered shape of the drive wheel for rope position control.

### BRIEF DESCRIPTION OF THE INVENTION

The object of the invention is to introduce an arrangement for condition monitoring of a rope of a hoisting apparatus, wherein information is provided on the multiple different types of defects, including delamination defects, as well as on the location of the damage along the length of the rope of a hoisting apparatus. Advantageous embodiments are furthermore presented, inter alia, wherein qualitative information about the damage magnitude is provided.

It is brought forward a new arrangement for condition monitoring of a rope of a hoisting apparatus, which rope comprises one or more conductive load bearing members for bearing the load exerted on the rope in longitudinal direction and extending parallel to each other and to the longitudinal direction of the rope, which arrangement comprises: one or more eddy current test units placed near said rope for generating a time-varying magnetic field, said time-varying magnetic field causing eddy currents in said rope, and for detecting a secondary magnetic field being generated by said eddy currents in said rope as eddy current detection data, and an on-line monitoring unit receiving and utilizing said eddy current detection data for on-line condition monitoring of said rope, wherein an at least one eddy current test unit of said one or more eddy current test units comprises: one or more printed circuit boards placed near said rope and arranged in a perpendicular direction in relation to the plane formed by adjacent load bearing members of said rope and parallel to each other, and arranged in a parallel direction or in a direction turned 20 degrees or less from the parallel direction in relation to the length of said rope, wherein at least one printed circuit board of said one or more printed circuit boards each comprises one or more eddy current inspection probes, each of said one or more eddy current inspection probes comprising two excitation coils and/or sensing coils arranged near said rope in said at least one printed circuit board. Hereby, one or more of the above-mentioned advantages and/or objectives are achieved. These advantages and/or objectives are further facilitated with the additional preferred features and/or steps described in the following.

In a preferred embodiment, said at least one eddy current test unit is arranged primarily for detecting delamination defects in the rope.

In a preferred embodiment, said one or more eddy current test units comprises an eddy current test unit arranged primarily for detecting fiber-breaking defects in the rope.

In a preferred embodiment, said on-line monitoring unit comprises a chassis that maintains the position of said one or more eddy current test units with regard to the rope.

In a preferred embodiment, said on-line monitoring unit is a movable eddy current testing device.

In a preferred embodiment, said movable eddy current testing device comprises positioning elements.

In a preferred embodiment, said at least one eddy current test unit comprises one printed circuit board of said one or more printed circuit boards for each conductive load bearing member in said rope.

In a preferred embodiment, said two excitation coils and/or sensing coils arranged in a perpendicular direction in relation to the plane formed by adjacent load bearing members of said rope and parallel to each other, and arranged in a parallel direction or in a direction turned 20 degrees or less from the parallel direction in relation to the length of said rope.

In a preferred embodiment, said two excitation coils and/or sensing coils arranged near a load bearing member and in a parallel direction or in a parallel direction or in a direction turned 20 degrees or less from the parallel direction in relation to the length of said load bearing member.

In a preferred embodiment, the windings of said two excitation coils and/or sensing coils have several turns in one or more layers.

In a preferred embodiment, the windings of said two excitation coils and/or sensing coils closer to the inspection surface of said rope are linear.

In a preferred embodiment, the windings of said two excitation coils and/or sensing coils closer to the inspection surface of said rope are arranged as a mirror image of one another.

In a preferred embodiment, in said at least one printed circuit board said two excitation coils and/or sensing coils are arranged 20-100 mm apart from each other.

In a preferred embodiment, said on-line monitoring unit is arranged for using said eddy current detection data for determination of the condition, the position, the alignment or the tension of said rope.

In a preferred embodiment, upon receiving eddy current detection data said on-line monitoring unit is arranged for providing one or more parameters for the determination of the condition, position, alignment or tension of the rope.

In a preferred embodiment, said on-line monitoring unit is arranged for providing for one or more parameters for determining whether there is any defect and/or damage in the rope.

In a preferred embodiment, said on-line monitoring unit is arranged for providing for one or more parameters for determining the location and/or position and/or type of a defect and/or damage in the rope.

In a preferred embodiment, said on-line monitoring unit is arranged for providing information for quantifying the severity of the defect and/or damage.

In a preferred embodiment, said on-line monitoring unit is arranged for performing on-line monitoring actions.

In a preferred embodiment, said at least one eddy current test unit is arranged for carrying out multiple measurements in detecting said eddy currents by changing signal form, signal amplitude and/or signal frequency of said generated time-varying magnetic field.

In a preferred embodiment, said at least one eddy current test unit comprises two eddy current test units arranged on both sides of the monitored rope or around the monitored rope.

In a preferred embodiment, said arrangement comprises a data storage for storing and retrieving said eddy current detection data.

It is also brought forward a new eddy current test unit of a condition monitoring arrangement of a rope of a hoisting apparatus, which rope comprises one or more conductive load bearing members for bearing the load exerted on the rope in longitudinal direction and extending parallel to each other and to the longitudinal direction of the rope, which arrangement comprises: one or more eddy current test units placed near said rope for generating a time-varying magnetic field, said time-varying magnetic field causing eddy currents in said rope, and for detecting a secondary magnetic field being generated by said eddy currents in said rope as eddy current detection data, and an on-line monitoring unit receiving and utilizing said eddy current detection data for on-line condition monitoring of said rope, wherein an at least one eddy current test unit of said one or more eddy current test units comprises: one or more printed circuit boards placed near said rope and arranged in a perpendicular direction in relation to the plane formed by adjacent load bearing members of said rope and parallel to each other, and arranged in a parallel direction or in a direction turned 20 degrees or less from the parallel direction in relation to the length of said rope, wherein at least one printed circuit board of said one or more printed circuit boards each comprises one or more eddy current inspection probes, each of said one or more eddy current inspection probes comprising two excitation coils and/or sensing coils arranged near said rope in said at least one printed circuit board.

### BRIEF DESCRIPTION OF THE DRAWINGS

In the following, the present invention will be described in more detail by way of example and with reference to the attached drawings, in which:

FIG. 1 illustrates a rope of a hoisting apparatus according to one embodiment of the present invention.

FIG. 2 illustrates a rope of a hoisting apparatus according to one embodiment of the present invention having a defect in the hoisting rope.

FIG. 3 illustrates a preferred inner structure of the load bearing member according to the present invention.

FIG. 4 illustrates a three dimensional view of a section of the load bearing member according to the present invention.

FIG. 5 illustrates a condition monitoring arrangement of an elevator according to one embodiment of the present invention.

FIG. 6 illustrates a side view of a movable eddy current testing device according to an embodiment of the present invention.

FIG. 7 illustrates a bottom view of a movable eddy current testing device according to an embodiment of the present invention.

FIG. 8 illustrates a perspective view of an eddy current test unit according to an embodiment of the present invention.

FIG. 9 illustrates another perspective view of an eddy current test unit according to an embodiment of the present invention.

FIG. 10 illustrates a partial front cross-sectional view of an eddy current test unit positioned for condition monitoring of a rope of a hoisting apparatus according to an embodiment of the present invention.

FIG. 11 illustrates a top cross-sectional view of an eddy current test unit positioned for condition monitoring of a rope of a hoisting apparatus according to an embodiment of the present invention.

FIG. 12 illustrates a partial side view of an eddy current test unit positioned for condition monitoring of a rope of a hoisting apparatus according to an embodiment of the present invention.

FIG. 13 illustrates a perspective view of an eddy current test unit according to another embodiment of the present invention.

FIG. 14 illustrates a partial front cross-sectional view of an eddy current test unit positioned for condition monitoring of a rope of a hoisting apparatus according to another embodiment of the present invention.

FIG. 15 illustrates a top cross-sectional view of an eddy current test unit positioned for condition monitoring of a rope of a hoisting apparatus according to another embodiment of the present invention.

FIG. 16 illustrates a principle of an eddy current test unit coils used for condition monitoring of a rope of a hoisting apparatus according to an embodiment of the present invention.

FIG. 17 illustrates a principle of an eddy current test unit coils used for condition monitoring of a defected rope of a hoisting apparatus according to an embodiment of the present invention.

FIG. 18 illustrates an example of a detected electromagnetic signal according to one embodiment of the present invention having defects in the rope.

The foregoing aspects, features and advantages of the invention will be apparent from the drawings and the detailed description related thereto.

### DETAILED DESCRIPTION

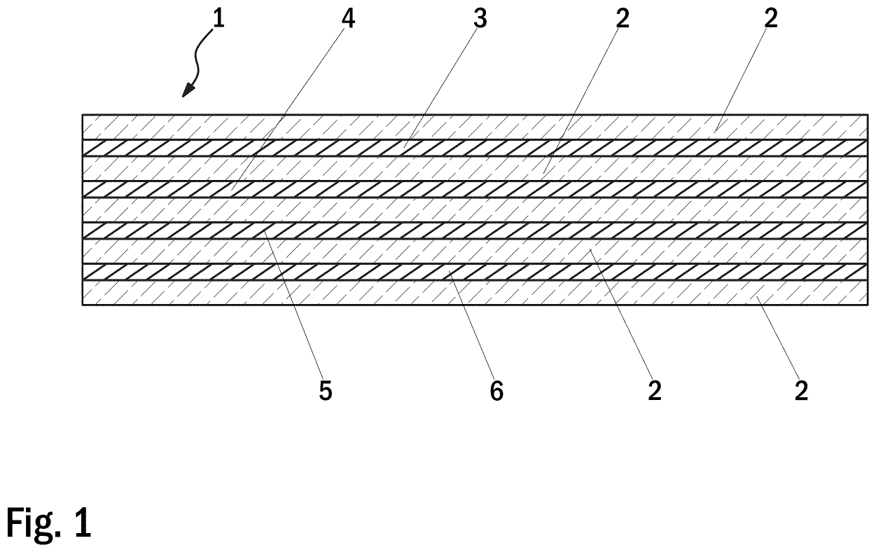

FIG. 1 illustrates a rope of a hoisting apparatus according to one embodiment of the present invention. In the presented embodiment, the hoisting rope 1 is belt-shaped, i.e. larger in width direction than thickness direction. The hoisting rope 1 comprises a non-conductive coating 2, and a plurality of conductive load bearing members 3-6 for bearing the load exerted on the hoisting rope 1 in longitudinal direction thereof, which are adjacent in width direction of the hoisting rope 1. The load bearing members 3-6 are embedded in the non-conductive coating 2 and extend parallel to each other as well as to the longitudinal direction of the hoisting rope 1 unbroken throughout the length of the hoisting rope 1. The coating 2 forms the surface of the hoisting rope 1 and extends between adjacent load bearing members 3-6, thereby isolating them from each other both mechanically and electrically. The coating 2 may also be referred to as lamination. The said conductive load bearing members 3-6 may be made of non-metal material. The said conductive load bearing members 3-6 may be made of composite material comprising electrically conducting reinforcing fibers in polymer matrix, said reinforcing fibers preferably being carbon fibers.

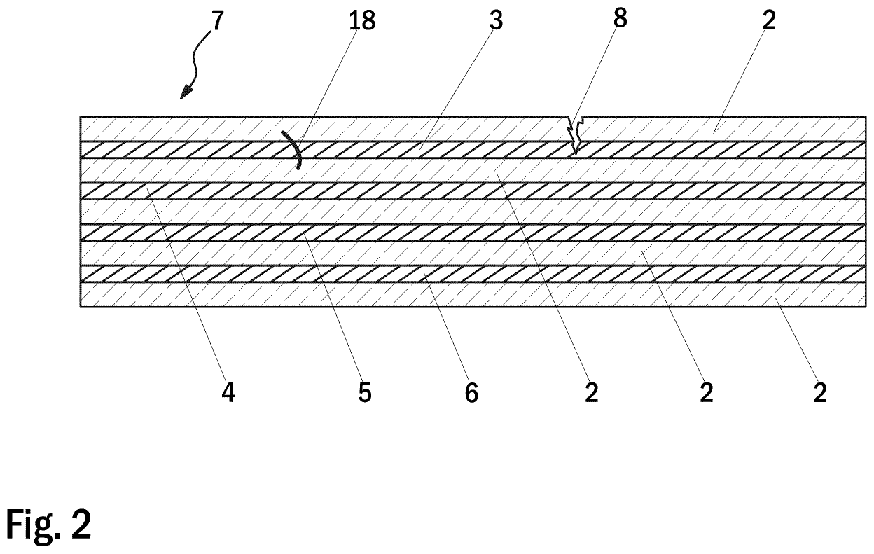

FIG. 2 illustrates a rope of a hoisting apparatus according to one embodiment of the present invention having a defect in the hoisting rope. The arrangement for condition monitoring of a hoisting rope of a hoisting apparatus presented in FIG. 2 is similar to that of presented in FIG. 1 with the exception of that there are defects 8, 18 in a first load bearing member 3 of the defected hoisting rope 7 of FIG. 2. The defected hoisting rope 7 is partially broken from a defect 8 in the middle part of the defected hoisting rope 7. A lamination defect in the defected hoisting rope 7 is marked with a reference number 18.

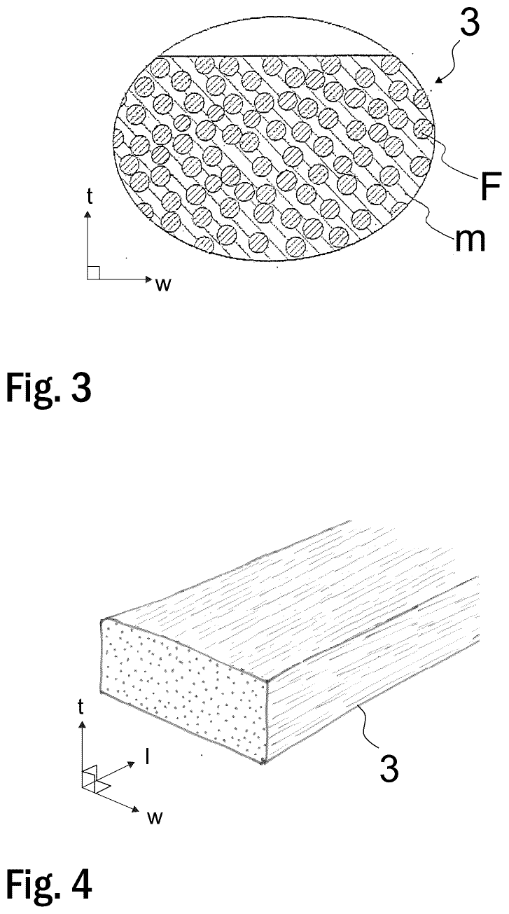

FIG. 3 illustrates a preferred inner structure of the load bearing member according to the present invention. In FIG. 3 the width direction w and the thickness direction t of a load bearing member 3 is shown. In FIG. 3 the cross section of the load bearing member 3 as viewed in the longitudinal direction I of the load bearing member 3 is shown in particular. The rope could alternatively have some other number of load bearing members 3, either more or less than what is disclosed in the Figures.

The load bearing members 3-6 are made of composite material comprising reinforcing fibers F embedded in polymer matrix m. The reinforcing fibers F are more specifically distributed in polymer matrix m and bound together by the polymer matrix, particularly such that an elongated rod-like piece is formed. Thus, each load bearing member 3-6 is one solid elongated rod-like piece. The reinforcing fibers F are distributed preferably substantially evenly in the polymer matrix m. Thereby a load bearing member with homogeneous properties and structure is achieved throughout its cross section. In this way, it can be also ensured that each of the fibers can be in contact and bonded with the matrix m. Said reinforcing fibers F are most preferably carbon fibers as they are electrically conducting and have excellent properties in terms of load bearing capacity, weight and tensile stiffness, which makes them particularly well suitable for use in elevator hoisting ropes. Alternatively, said reinforcing fibers F can be of any other fiber material which is electrically conducting. The matrix m comprises preferably of epoxy, but alternative materials could be used depending on the preferred properties. Preferably, substantially all the reinforcing fibers F of each load bearing member 3-6 are parallel with the longitudinal direction of the load bearing member 3-6. Thereby the fibers are also parallel with the longitudinal direction of the hoisting rope 1 as each load bearing member is oriented parallel with the longitudinal direction of the hoisting rope 1. Thereby, the fibers in the final hoisting rope 1 will be aligned with the force when the hoisting rope 1 is pulled, which ensures that the structure provides high tensile stiffness. This is also advantageous for achieving unproblematic behavior of the internal structure, particularly internal movement, when the hoisting rope 1 is bent.

The fibers F used in the preferred embodiments are substantially untwisted in relation to each other, which provides them said orientation parallel with the longitudinal direction of the hoisting rope 1. This is in contrast to the conventionally twisted elevator ropes, where the wires or fibers are strongly twisted and have normally a twisting angle from 15 up to 30 degrees, the fiber/wire bundles of these conventionally twisted elevator ropes thereby having the potential for transforming towards a straighter configuration under tension, which provides these ropes a high elongation under tension as well as leads to an unintegral structure.

The reinforcing fibers F are preferably long continuous fibers in the longitudinal direction of the load bearing member, the fibers F preferably continuing for the whole length of the load bearing member 3-6 as well as the hoisting rope 1. Thus, the load bearing ability, good conductivity as well as manufacturing of the load bearing member 3-6 are facilitated. The fibers F being oriented parallel with longitudinal direction of the hoisting rope 1, as far as possible, the cross section of the load bearing member 3-6 can be made to continue substantially the same in terms of its cross-section for the whole length of the hoisting rope 1. Thus, no substantial relative movement can occur inside the load bearing member 3-6 when it is bent.

As mentioned, the reinforcing fibers F are preferably distributed in the aforementioned load bearing member 3-6 substantially evenly, in particular as evenly as possible, so that the load bearing member 3-6 would be as homogeneous as possible in the transverse direction thereof. An advantage of the structure presented is that the matrix m surrounding the reinforcing fibers F keeps the interpositioning of the reinforcing fibers F substantially unchanged. It equalizes with its slight elasticity the distribution of a force exerted on the fibers, reduces fiber-fiber contacts and internal wear of the hoisting rope, thus improving the service life of the hoisting rope 1. The composite matrix m, into which the individual fibers F are distributed as evenly as possible, is most preferably made of epoxy, which has good adhesion to the reinforcement fibers F and which is known to behave advantageously with carbon fiber. Alternatively, e.g. polyester or vinyl ester can be used, but alternatively any other suitable alternative materials can be used. FIG. 3 presents inside the circle a partial cross-section of the load bearing member 3-6 close to the surface thereof as viewed in the longitudinal direction of the hoisting rope 1. The reinforcing fibers F of the load bearing member 3-6 are preferably organized in the polymer matrix m according to this cross-section. The rest (parts not showed) of the load bearing member 3-6 have a similar structure.

FIG. 4 illustrates a three dimensional view of a section of the load bearing member according to the present invention. From the presented FIG. 3 and FIG. 4 it can also be seen how the individual reinforcing fibers F of a load bearing member 3 are substantially evenly distributed in the polymer matrix m, which surrounds the reinforcing fibers F. The polymer matrix m fills the areas between individual reinforcing fibers F and binds substantially all the reinforcing fibers F that are inside the matrix m to each other as a uniform solid substance. A chemical bond exists between, the individual reinforcing fibers F (preferably each of them) and the matrix m, one advantage of which is uniformity of the structure. To improve the chemical adhesion of the reinforcing fiber to the matrix m, in particular to strengthen the chemical bond between the reinforcing fiber F and the matrix m, each fiber can have a thin coating, e.g. a primer (not presented) on the actual fiber structure between the reinforcing fiber structure and the polymer matrix m. However, this kind of thin coating is not necessary. The properties of the polymer matrix m can also be optimized as it is common in polymer technology. For example, the matrix m can comprise a base polymer material (e.g. epoxy) as well as additives, which fine-tune the properties of the base polymer such that the properties of the matrix are optimized. The polymer matrix m is preferably of a hard non-elastomer as in this case a risk of buckling can be reduced for instance. However, the polymer matrix need not be non-elastomer necessarily, e.g. if the downsides of this kind of material are deemed acceptable or irrelevant for the intended use. In that case, the polymer matrix m can be made of elastomer material such as polyurethane or rubber for instance. The reinforcing fibers F being in the polymer matrix means here that the individual reinforcing fibers F are bound to each other with a polymer matrix m, e.g. in the manufacturing phase by immersing them together in the fluid material of the polymer matrix which is thereafter solidified. In this case the gaps of individual reinforcing fibers bound to each other with the polymer matrix comprise the polymer of the matrix. In this way a great number of reinforcing fibers bound to each other in the longitudinal direction of the hoisting rope are distributed in the polymer matrix. As mentioned, the reinforcing fibers are preferably distributed substantially evenly in the polymer matrix m, whereby the load bearing member is as homogeneous as possible when viewed in the direction of the cross-section of the hoisting rope. In other words, the fiber density in the cross-section of the load bearing member 3-6 does not therefore vary substantially. The individual reinforcing fibers of the load bearing member 3-6 are mainly surrounded with polymer matrix m, but random fiber-fiber contacts can occur because controlling the position of the fibers in relation to each other in their simultaneous impregnation with polymer is difficult, and on the other hand, perfect elimination of random fiber-fiber contacts is not necessary from the viewpoint of the functioning of the solution. If, however, it is desired to reduce their random occurrence, the individual reinforcing fibers F can be pre-coated with material of the matrix m such that a coating of polymer material of said matrix is around each of them already before they are brought and bound together with the matrix material, e.g. before they are immersed in the fluid matrix material.

In the case of delamination of a load bearing member 3-6 the polymer matrix no longer supports all of the individual reinforcing fibers in a load bearing member 3-6. Consequently, in delamination some of said individual reinforcing fibers detach from one another in the longitudinal direction.

As above mentioned, the matrix m of the load bearing member 3-6 is most preferably hard in its material properties. A hard matrix m helps to support the reinforcing fibers F, especially when the hoisting rope bends, preventing buckling of the reinforcing fibers F of the bent rope, because the hard material supports the fibers F efficiently. To reduce the buckling and to facilitate a small bending radius of the load bearing member 3-6, among other things, it is therefore preferred that the polymer matrix m is hard, and in particular non-elastomeric. The most preferred materials for the matrix are epoxy resin, polyester, phenolic plastic or vinyl ester. The polymer matrix m is preferably so hard that its module of elasticity E is over 2 GPa, most preferably over 2.5 GPa. In this case the module of elasticity E is preferably in the range 2.5-10 GPa, most preferably in the range 2.5-3.5 GPa. There are commercially available various material alternatives for the matrix m which can provide these material properties.

Preferably over 50% of the surface area of the cross-section of the load bearing member 3-6 is of the aforementioned electrically conducting reinforcing fiber. Thereby, good conductivity can be ensured. Fibers F will be in contact with each other randomly along their length whereby magnetic fields signal inserted into the load bearing member remains within substantially the whole cross section of the load bearing member. To be more precise preferably 50%-80% of the surface area of the cross-section of the load bearing member 3-6 is of the aforementioned reinforcing fiber, most preferably such that 55%-70% is of the aforementioned reinforcing fiber, and substantially all the remaining surface area is of polymer matrix. In this way conductivity and longitudinal stiffness of the load bearing member 3-6 are facilitated yet there is enough matrix material to bind the fibers F effectively to each other. Most preferably, this is carried out such that approx. 60% of the surface area is of reinforcing fiber and approx. 40% is of matrix material.

Eddy-current testing is commonly used method in non-destructive testing. In its most basic form a test coil of conductive wire is excited with an alternating electrical current. This test coil wire produces an alternating magnetic field around itself in the direction ascertained by the right-hand rule. The magnetic field oscillates at the same frequency as the current running through the coil. When the test coil approaches a conductive material, eddy currents opposed to the ones in the test coil are induced in the material of the test object. Variations in the electrical conductivity and magnetic permeability of the test object, and the presence of defects causes a change in eddy current and a corresponding change in the measured phase and/or amplitude of the test coil impedance that can be detected, which indicates the presence of defects.

As the frequency of the test coil is increased, the eddy currents tend to concentrate near the surface of the conductor, and at sufficiently high frequencies, the result is the well-known skin effect. Because eddy current flow is confined to a region bounded by the surface of the specimen and the skin depth associated with the selected test frequency, the test frequency may be selected according to the test arrangement for better test indications.

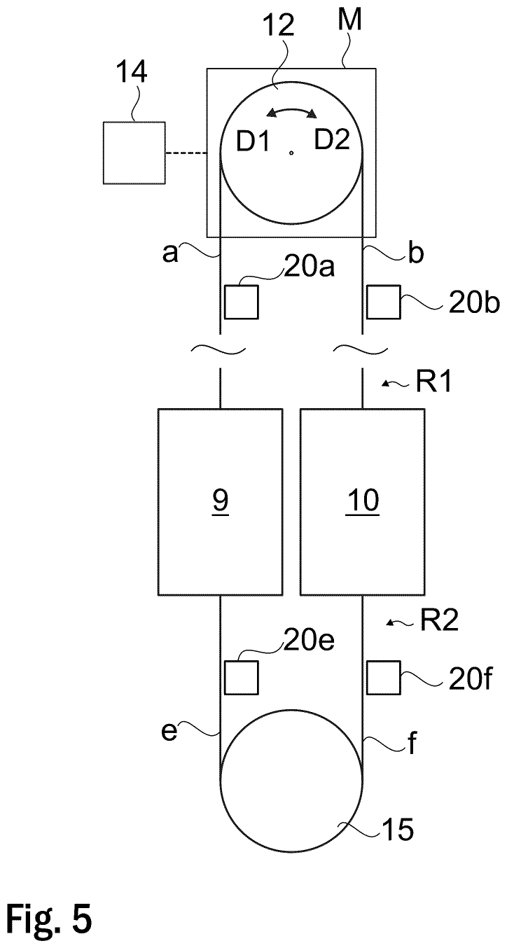

FIG. 5 illustrates a condition monitoring arrangement of an elevator according to another embodiment of the present invention. The elevator comprises a hoistway and a first elevator unit 9 vertically movable in the hoistway and a second elevator unit 10 vertically movable in the hoistway. At least one of said elevator units 9, 10 is an elevator car for receiving a load to be transported i.e. goods and/or passengers. The other one is preferably a counterweight, but alternatively it could be a second elevator car.

The elevator further comprises a first roping R1 comprising one or more ropes, i.e. one or more belt-shaped hoisting ropes, interconnecting the first elevator unit 9 and the second elevator unit 10 and passing around a drive wheel 12. The elevator further comprises a second roping R2 comprising one or more ropes, i.e. one or more belt-shaped hoisting ropes, interconnecting the first elevator unit 9 and the second elevator unit 10 and passing around a compensation wheel 15.

Each of said one or more belt-shaped ropes of said first roping R1 passes around the drive wheel 12 and comprises consecutively a first rope section a extending between the drive wheel 12 and the first elevator unit 9, and a second rope section b extending between the drive wheel 12 and the second elevator unit 10. Thus, each said first rope section a is on one side of the drive wheel and each said second rope section b is on the other (opposite) side of the drive wheel 12. The elevator comprises a motor M for rotating the drive wheel 12 engaging the one or more hoisting ropes whereby motorized rotation of the drive wheel 12 is enabled. In FIG. 5, the two rotation directions D1, D2 of the drive wheel 12 are marked as D1 and D2. The elevator further comprises an automatic elevator control 14 arranged to control the motor M. Thereby movement of the elevator units 9, 10 is automatically controllable.

Each of said one or more belt-shaped ropes of said second roping R2, i.e. compensation roping R2, passes around the compensation wheel 15 and comprises consecutively a third rope section e extending between the compensation wheel 15 and the first elevator unit 9, and a fourth rope section f extending between the compensation wheel 15 and the second elevator unit 10. Thus, each said first rope section e is on one side of the compensation wheel and each said second rope section f is on the other (opposite) side of the compensation wheel 15.

The elevator according to the present embodiment further comprises a condition monitoring arrangement configured to monitor the condition, the position, the tension and the alignment, i.e. displacement, of each of said rope sections a, b, e, fin the axial direction of the rope wheels 12, 15. Each of said one or more belt-shaped ropes of said first roping R1 and of said second roping R2 comprises one or more conductive load bearing members for bearing the load exerted on the rope in longitudinal direction and extending parallel to each other and to the longitudinal direction of the rope. Said condition monitoring arrangement comprises an at least one eddy current test unit 20a, 20b, 20e, 20f, and an on-line monitoring unit.

In the condition monitoring arrangement according to the present invention said at least one eddy current test unit 20a, 20b, 20e, 20f is placed near the monitored rope for generating a time-varying magnetic field, said time-varying magnetic field causing eddy currents in said rope and for detecting a secondary magnetic field being generated by said eddy currents in said rope as eddy current detection data. In the condition monitoring arrangement according to the present invention said on-line monitoring unit is arranged to receive and utilize said eddy current detection data for on-line condition monitoring of said rope.

In the embodiment of the present invention presented in FIG. 5 the condition monitoring arrangement is configured to monitor the condition, the position, the tension and the alignment of each of said first rope sections a as defined with at least one first eddy current test unit 20a, and displacement of each of said second rope sections b as defined with at least one second eddy current test unit 20b. Respectively, the condition monitoring arrangement is configured to monitor the condition, the position, the tension and the alignment of each of said third rope sections e as defined with at least one first eddy current test unit 20e, and displacement of each of said second rope sections f as defined with at least one second eddy current test unit 20f. Accordingly, the condition of each rope section is monitored with separate eddy current test units.

Said condition monitoring arrangement comprises a first eddy current test unit 20a configured to detect displacement of each of said first rope sections a in the axial direction of the drive wheel 12 away from a predefined zone, a second eddy current test unit 20b configured to detect displacement of each of said second rope sections b in the axial direction of the drive wheel 12 away from a predefined zone, a third eddy current test unit 20a configured to detect displacement of each of said third rope sections e in the axial direction of the compensation wheel 15 away from a predefined zone, and a fourth eddy current test unit 20f configured to detect displacement of each of said fourth rope sections f in the axial direction of the compensation wheel 15 away from a predefined zone. In the condition monitoring arrangement according to the present invention said at least one eddy current test unit 20a, 20b, 20e, 20f may be positioned close to the rope wheels 12, 15.

In addition to monitoring the condition of hoisting roping and compensation roping, the condition monitoring arrangement according to the present invention may be arranged to monitor the condition, the position, the tension and the alignment of an overspeed governor roping.

With the help of said eddy current detection data an on-line monitoring unit of said condition monitoring arrangement is able determine the types of the defects and condition as well as the position, the alignment and the tension of the hoisting rope. Furthermore, said eddy current detection data may provide said on-line monitoring unit information about the location and/or position of a defect and/or damage so as to determine said location of the defect and/or damage. Furthermore, said eddy current detection data may provide said on-line monitoring unit information for quantifying the severity of the defect and/or damage such as e.g. fiber damage or delamination. Each one of said eddy current test units 20a, 20b, 20e, 20f may comprise several inspection probes. The eddy current test units 20a, 20b, 20e, 20f may be arranged as a permanent installation or alternatively as movable eddy current test units or as portable eddy current test units. Even when arranged as a permanent installation the eddy current test units 20a, 20b, 20e, 20f may still be arranged as movable, i.e. positionable, in relation to the monitored rope.

The eddy current test units 20a, 20b, 20e, 20f of said condition monitoring arrangement may be arranged on both sides of the monitored rope or arranged around the monitored rope. The eddy current test units 20a, 20b, 20f may comprise one or more hinges for allowing proper positioning of said test units 20a, 20b, 20e, 20f. The eddy current test units 20a, 20b, 20e, 20f of said condition monitoring arrangement may be arranged to carry out measurements in detecting said secondary magnetic field. One or more of said eddy current test unit may comprise one or more bridge-type inspection probes and/or one or more reflection-type inspection probes. Each of said eddy current test unit may comprise one or more excitation coils and/or excitation filaments and one or more sensing coils and/or sensing filaments.

The excitation coils and/or the excitation filaments and/or the sensing coils and/or the sensing filaments may be arranged in a planar arrangement so that the excitation direction and/or the sensing direction is parallel to the load bearing members 3-6 of the monitored rope 1 or parallel to individual reinforcing fibers F of the load bearing members 3-6 of the monitored rope 1. Said planar arrangement may also be arranged as parallel to a plane formed by adjacent load bearing members 3-6 of a monitored rope 1. The excitation coils and/or the excitation filaments and/or the sensing coils and/or the sensing filaments may also be arranged in a three-dimensional arrangement so that the excitation direction the sensing direction is parallel to the load bearing members 3-6 of the monitored rope 1. In a three-dimensional arrangement, at least a part of the excitation coils and/or the excitation filaments and/or the sensing coils and/or the sensing filaments may also be arranged in a perpendicular direction in relation to the load bearing members 3-6 of the monitored rope 1. This helps especially in the detection of delamination of the load bearing members 3-6 of the monitored rope 1. Furthermore, at least a part of the excitation coils and/or the excitation filaments and/or the sensing coils and/or the sensing filaments may also be arranged in a perpendicular direction in relation to the plane formed by adjacent load bearing members 3-6 of a monitored rope 1.

Furthermore, at least a part of the excitation filaments and/or the sensing filaments may also be arranged parallel to the load bearing members 3-6 of the monitored rope 1 or parallel to individual reinforcing fibers F of the load bearing members 3-6 of the monitored rope 1. Furthermore, at least a part of the excitation coils and/or the excitation filaments and/or the sensing coils and/or the sensing filaments may also be arranged as interlacing each other. This reduces disturbances in the measurement of adjacent load bearing members 3-6 of the monitored rope 1.

Said excitation coils and/or sensing coils may have a width of less than or equal to the width of said rope 1. Said eddy current test units 20a, 20b, 20e, 20f of said condition monitoring arrangement may have different shapes, forms or geometries, including planar shapes and three-dimensional (3D) shapes. Said eddy current test units 20a, 20b, 20e, 20f may be used without contact to said rope, e.g. within a measurement distance of less than 10 mm from said rope. Said eddy current test units 20a, 20b, 20e, 20f may have an inspection speed of less than 22 m/s. Said eddy current test units 20a, 20b, 20e, 20f may have a detecting frequency of 2 kHz-30 MHz. Said condition monitoring arrangement may also comprise a data storage for storing and retrieving said eddy current detection data.

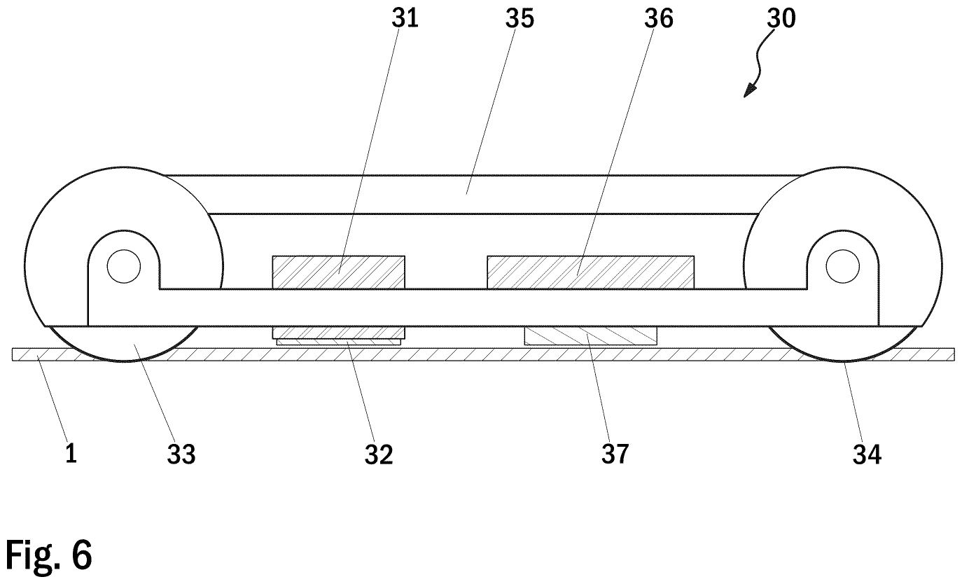

FIG. 6 illustrates a side view of a movable eddy current testing device according to an embodiment of the present invention. In the presented embodiment, the movable eddy current testing device 30 comprises two eddy current test units 31, 36 arranged in a movable enclosure. In the presented embodiment, the movable eddy current testing device 30 comprises a chassis that maintains the position of the test units with regard to the rope.

The eddy current test units 31, 36 are placed in the middle of the movable eddy current testing device 30 and its positioning and constant lift off is assured by it. One eddy current test unit 31 may be arranged primarily for detecting fiber-breaking defects in the monitored rope 1, whereas another eddy current test unit 36 may be arranged primarily for detecting delamination defects in the monitored rope 1.

Each one of said two eddy current test units 31, 36 comprises an at least one inspection unit 32, 37. In the movable eddy current testing device according to an embodiment of the present invention said eddy current test units 31, 36 may e.g. comprise one inspection unit 32, 37 for each conductive load bearing member in the monitored rope 1. In FIG. 6, the detailed structure of the inspection unit 37 is not shown. Said eddy current test units 31, 36 are placed in the middle of the movable eddy current testing device 30 to ensure positioning of excitation coils and/or sensing coils of said at least one d inspection unit 32, 37 in relation to the geometry of the monitored rope 1. The placement of said eddy current test units 31, 36 is arranged so that magnetic fields are not interacting/disturbing themselves.

The movable eddy current testing device 30 may comprise a grip handle 35. The movable eddy current testing device 30 comprises positioning elements 33, 34, e.g. positioning wheels 33, 34, for appropriate positioning of said movable eddy current testing device 30 in relation to the monitored rope 1. The positioning wheels 33, 34 work like train wheels and the monitored rope 1 serves as the rail. This guarantees the transversal positioning of the eddy current test units 31, 36 relative to the monitored rope 1.

In an alternative embodiment, the movable eddy current testing device 30 may comprise optical positioning elements for appropriate positioning of said movable eddy current testing device 30 in relation to the monitored rope 1. The movable eddy current testing device 30 may be used for condition monitoring of a rope 1 of a hoisting apparatus, e.g. elevator.

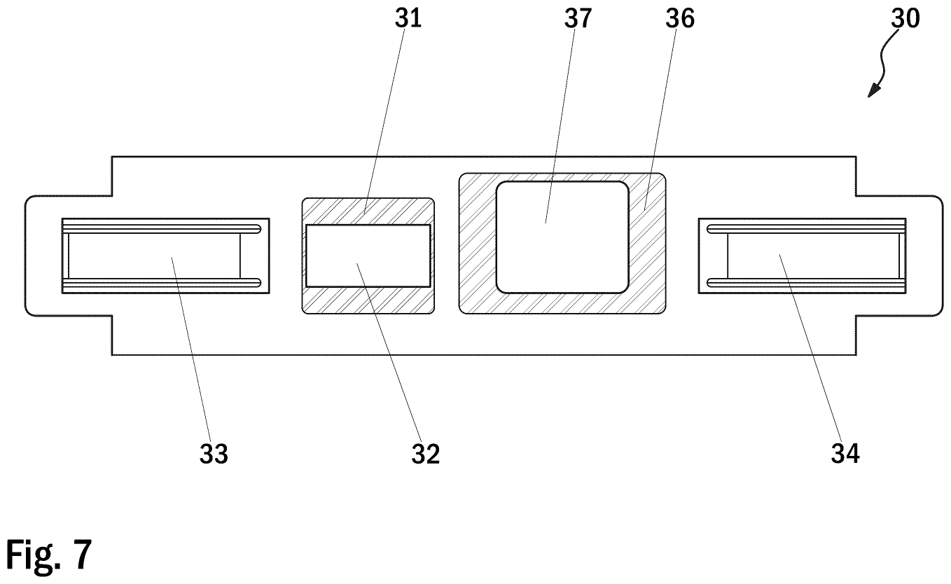

FIG. 7 illustrates a bottom view of a movable eddy current testing device according to an embodiment of the present invention. In the presented embodiment the movable eddy current testing device 30 comprises two eddy current test units 31, 36 arranged in a movable enclosure. Each one of said two eddy current test units 31, 36 comprises an at least one inspection unit 32, 37. In the movable eddy current testing device according to an embodiment of the present invention said eddy current test units 31, 36 may e.g. comprise one inspection unit 32, 37 for each conductive load bearing member in the monitored rope. In FIG. 7, the detailed structure of the inspection unit 37 is not shown. The movable eddy current testing device 30 comprises positioning elements 33, 34, e.g. positioning wheels 33, 34, for appropriate positioning of said movable eddy current testing device 30 in relation to the monitored rope.

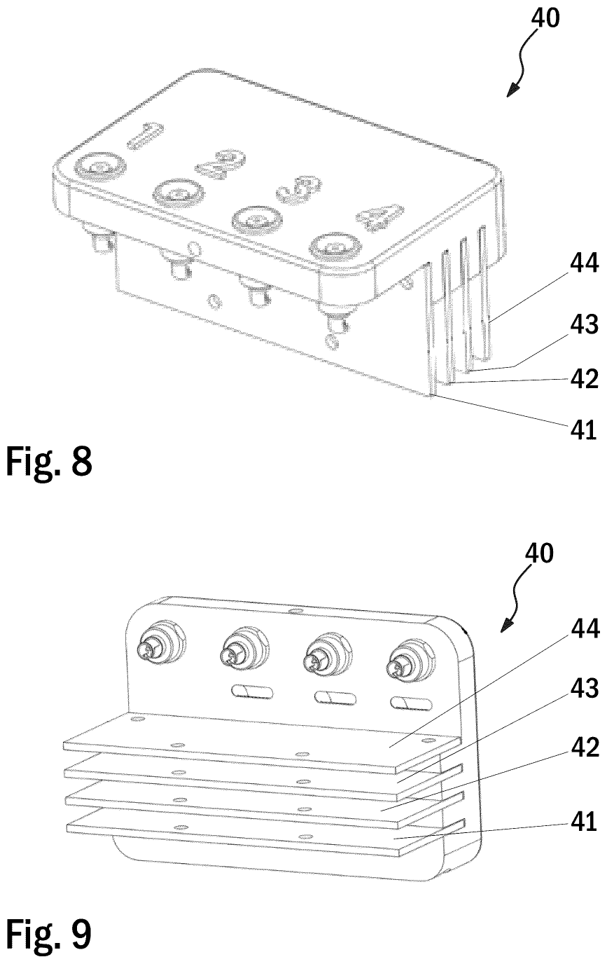

FIG. 8 illustrates a perspective view of an eddy current test unit according to an embodiment of the present invention. In the presented embodiment, the eddy current test unit 40 comprises one or more printed circuit boards 41-44, each of said one or more printed circuit boards 41-44 comprising one or more eddy current inspection probes, each of said one or more eddy current inspection probes comprising two excitation coils and/or sensing coils.

In an alternative solution, the eddy current test unit 40 may comprise two or more printed circuit boards. In another alternative solution, the eddy current test unit 40 may comprise four or more printed circuit boards. In the presented embodiment, the eddy current test unit 40 comprises four printed circuit boards 41-44. The eddy current test unit 40 may also comprise an additional circuit board/circuit boards in addition to said one or more printed circuit boards 41-44.

FIG. 9 illustrates another perspective view of an eddy current test unit according to an embodiment of the present invention. In the presented embodiment, the eddy current test unit 40 comprises one or more printed circuit boards 41-44, each of said one or more printed circuit boards 41-44 comprising one or more eddy current inspection probes, each of said one or more eddy current inspection probes comprising two excitation coils and/or sensing coils.

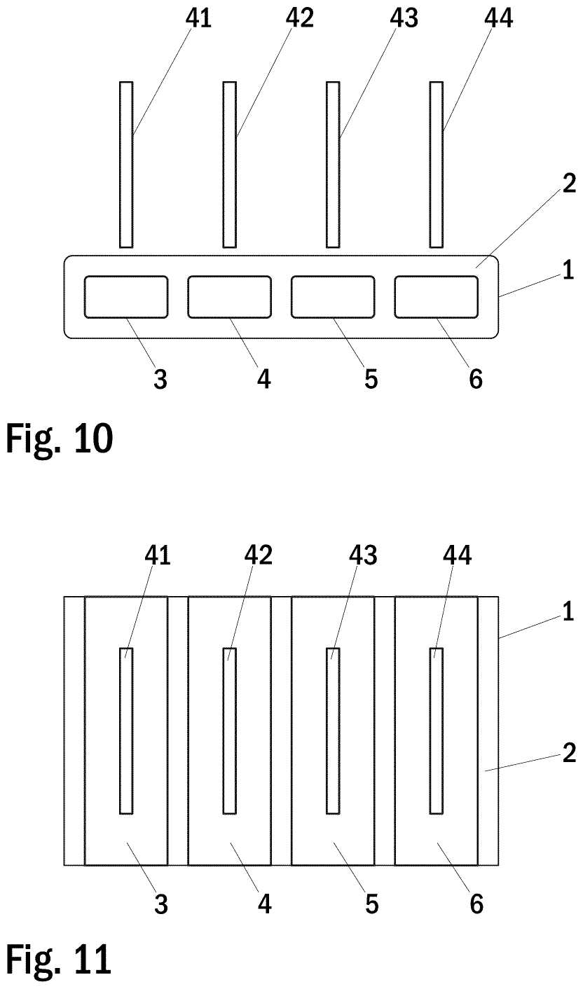

FIG. 10 illustrates a partial front cross-sectional view of an eddy current test unit positioned for condition monitoring of a rope of a hoisting apparatus according to an embodiment of the present invention. As illustrated in FIG. 10, in condition monitoring said one or more printed circuit boards 41-44 of said eddy current test unit 40 are arranged in an upright position, i.e. in a perpendicular direction in relation to the plane formed by adjacent load bearing members 3-6 of a monitored rope 1. Furthermore, in condition monitoring each of said one or more printed circuit boards 41-44 of said eddy current test unit 40 are placed near said monitored rope 1 and arranged parallel to each other and in a parallel direction in relation to the length of said monitored rope 1.

Likewise, in condition monitoring each of said one or more printed circuit boards 41-44 are also placed near one of said load bearing members 3-6 of a monitored rope 1 and arranged in a perpendicular direction in relation to the width said respective load bearing member 3-6 and arranged in a parallel direction in relation to the length of said respective load bearing member 3-6. The coating, i.e. the lamination of said monitored rope 1 is indicated with a reference number 2.

FIG. 11 illustrates a top cross-sectional view of an eddy current test unit positioned for condition monitoring of a rope of a hoisting apparatus according to an embodiment of the present invention. As illustrated in FIG. 11, in condition monitoring said one or more printed circuit boards 41-44 of said eddy current test unit 40 are arranged in an upright position, i.e. in a perpendicular direction in relation to the plane formed by adjacent load bearing members 3-6 of a monitored rope 1. Furthermore, in condition monitoring each of said one or more printed circuit boards 41-44 of said eddy current test unit 40 are placed near said monitored rope 1 and arranged parallel to each other and in a parallel direction in relation to the length of said monitored rope 1. Likewise, in condition monitoring each of said one or more printed circuit boards 41-44 are also placed near one of said load bearing members 3-6 of a monitored rope 1 and arranged in a perpendicular direction in relation to the width said respective load bearing member 3-6 and arranged in a parallel direction in relation to the length of said respective load bearing member 3-6. The coating, i.e. the lamination of said monitored rope 1 is indicated with a reference number 2.

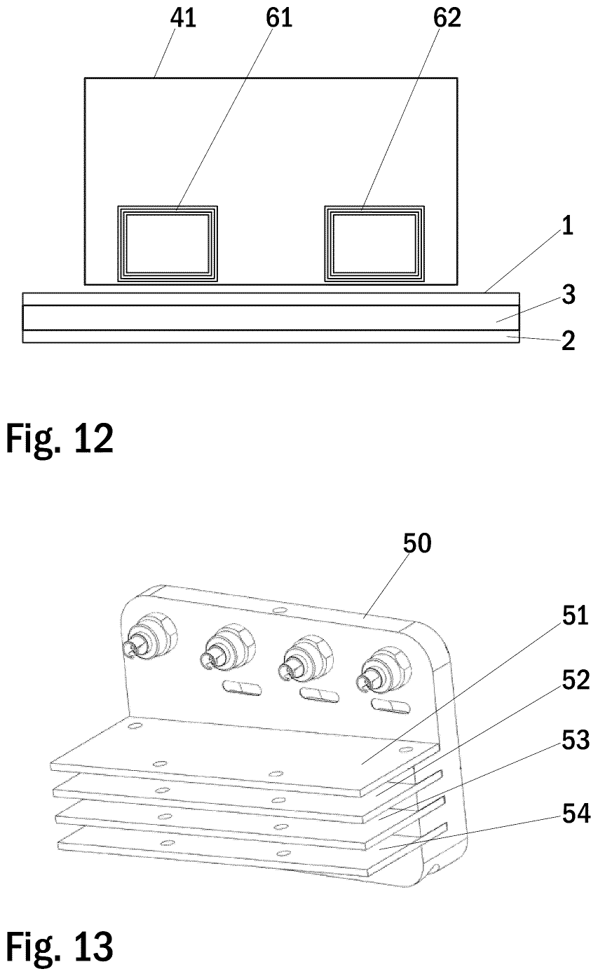

FIG. 12 illustrates a partial side view of an eddy current test unit positioned for condition monitoring of a rope of a hoisting apparatus according to an embodiment of the present invention. As illustrated in FIG. 12, a printed circuit board 41 of said one or more printed circuit boards 41-44 is arranged in an upright position, i.e. in a perpendicular direction in relation to the plane formed by adjacent load bearing members 3-6 of a monitored rope 1. Furthermore, said printed circuit board 41 is placed near said monitored rope 1 and arranged in a parallel direction in relation to the length of said monitored rope 1. Likewise, said printed circuit board 41 is also placed near one load bearing member 3 of said load bearing members 3-6 and arranged in a perpendicular direction in relation to the width said respective load bearing member 3 and arranged in a parallel direction in relation to the length of said respective load bearing member 3. The coating, i.e. the lamination of said monitored rope 1 is indicated with a reference number 2.

In the embodiment of the present invention, said printed circuit board 41 comprises two or more excitation/sensing coils/filaments 61, 62 arranged apart from each other. Said excitation/sensing coils/filaments 61, 62 are arranged in said printed circuit board 41 so that they are near said monitored rope 1 and near said load bearing member 3. Furthermore, said excitation/sensing coils/filaments 61, 62 are arranged in a perpendicular direction in relation to the width said respective load bearing member 3 and arranged in a parallel direction in relation to the length of said respective load bearing member 3. In said printed circuit board 41 the excitation/sensing coils/filaments 61, 62 are arranged apart from each other, e.g. 20-100 mm apart from each other.

In the embodiment presented in FIG. 12, said excitation/sensing coils/filaments 61, 62 are arranged in said printed circuit board so that they are near said monitored rope 1 and near said load bearing member. Furthermore, said excitation/sensing coils/filaments 61, 62 are arranged in an upright position, i.e. in a perpendicular direction in relation to the plane formed by adjacent load bearing members of a monitored rope 1. In the presented embodiment, the windings of said excitation/sensing coils/filaments 61, 62 closer to the inspection surface of said monitored rope 1 are arranged as a mirror image of one another. The windings of said excitation/sensing coils/filaments 61, 62 may have several turns in one or more layers. Furthermore, said windings of said excitation/sensing coils/filaments 61, 62 closer to the inspection surface of said monitored rope 1 may be linear. In the embodiment presented in FIG. 12, a time-varying magnetic field is generated in said monitored rope 1 using said excitation/sensing coils/filaments 61, 62. Said generated time-varying magnetic field may be an alternating magnetic field generated by using alternating current. Said generated time-varying magnetic field may also be a step function or any other time-varying magnetic field generated by using any other time-varying current. Furthermore, eddy currents in said monitored rope 1 caused by said generated time-varying magnetic field is detected using said excitation/sensing coils/filaments 61, 62.

FIG. 13 illustrates a perspective view of an eddy current test unit according to another embodiment of the present invention. In the presented another embodiment, the eddy current test unit 50 comprises one or more printed circuit boards 51-54, each of said one or more printed circuit boards 51-54 comprising one or more eddy current inspection probes, each of said one or more eddy current inspection probes comprising two excitation coils and/or sensing coils. In the embodiment of FIG. 13, each of said one or more printed circuit boards 51-54 of said eddy current test unit 50 are turned 20 degrees or less from the direction of the respective printed circuit boards 41-44 of the eddy current test unit 40 presented in FIG. 9.

In an alternative solution, the eddy current test unit 50 may comprise two or more printed circuit boards. In another alternative solution, the eddy current test unit 50 may comprise four or more printed circuit boards. In the presented embodiment, the eddy current test unit 50 comprises four printed circuit boards 51-54.

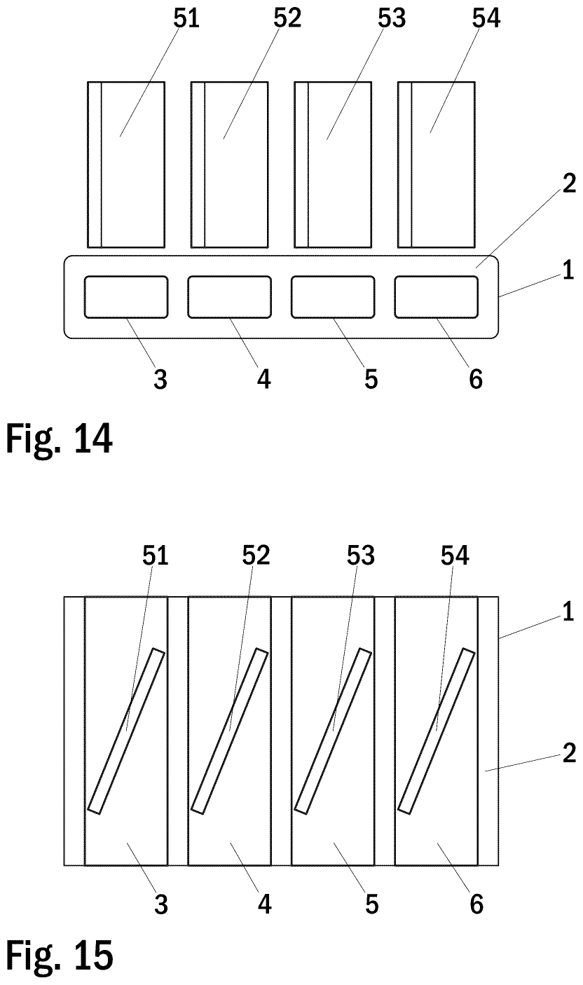

FIG. 14 illustrates a partial front cross-sectional view of an eddy current test unit positioned for condition monitoring of a rope of a hoisting apparatus according to another embodiment of the present invention. As illustrated in FIG. 14, in condition monitoring said one or more printed circuit boards 51-54 of said eddy current test unit 50 are arranged in an upright position, i.e. in a perpendicular direction in relation to the plane formed by adjacent load bearing members 3-6 of a monitored rope 1. Furthermore, in condition monitoring each of said one or more printed circuit boards 51-54 of said eddy current test unit 50 are placed near said monitored rope 1 and arranged parallel to each other and in a direction turned 20 degrees or less from the parallel direction in relation to the length of said monitored rope 1.

Likewise, in condition monitoring each of said one or more printed circuit boards 51-54 are also placed near one of said load bearing members 3-6 of a monitored rope 1 and arranged in a perpendicular direction in relation to the width said respective load bearing member 3-6 and arranged in a direction turned 20 degrees or less from the parallel direction in relation to the length of said respective load bearing member 3-6. Furthermore, the excitation/sensing coils/filaments in each of said one or more printed circuit boards 51-54 are arranged in a perpendicular direction in relation to the width said respective load bearing member 3 and arranged in a direction turned 20 degrees or less from the parallel direction in relation to the length of said respective load bearing member 3. The coating, i.e. the lamination of said monitored rope 1 is indicated with a reference number 2.

FIG. 15 illustrates a top cross-sectional view of an eddy current test unit positioned for condition monitoring of a rope of a hoisting apparatus according to another embodiment of the present invention. As illustrated in FIG. 15, in condition monitoring said one or more printed circuit boards 51-54 of said eddy current test unit 50 are arranged in an upright position, i.e. in a perpendicular direction in relation to the plane formed by adjacent load bearing members 3-6 of a monitored rope 1. Furthermore, in condition monitoring each of said one or more printed circuit boards 51-54 of said eddy current test unit 50 are placed near said monitored rope 1 and arranged parallel to each other and in a direction turned 20 degrees or less from the parallel direction in relation to the length of said monitored rope 1.

Likewise, in condition monitoring each of said one or more printed circuit boards 51-54 are also placed near one of said load bearing members 3-6 of a monitored rope 1 and arranged in a perpendicular direction in relation to the width said respective load bearing member 3-6 and arranged in a direction turned 20 degrees or less from the parallel direction in relation to the length of said respective load bearing member 3-6. Furthermore, the excitation/sensing coils/filaments in each of said one or more printed circuit boards 51-54 are arranged in a perpendicular direction in relation to the width said respective load bearing member 3 and arranged in a direction turned 20 degrees or less from the parallel direction in relation to the length of said respective load bearing member 3. The coating, i.e. the lamination of said monitored rope 1 is indicated with a reference number 2.

Eddy currents always follow the path of least electrical resistance around non-conducting obstacles, flowing under long, shallow discontinuities and flowing around short, deep discontinuities. Although the paths of eddy currents are circular, eddy currents behave like compressive fluids and the flow paths of the eddy currents will distort and compress to accommodate intrusions into their flow.

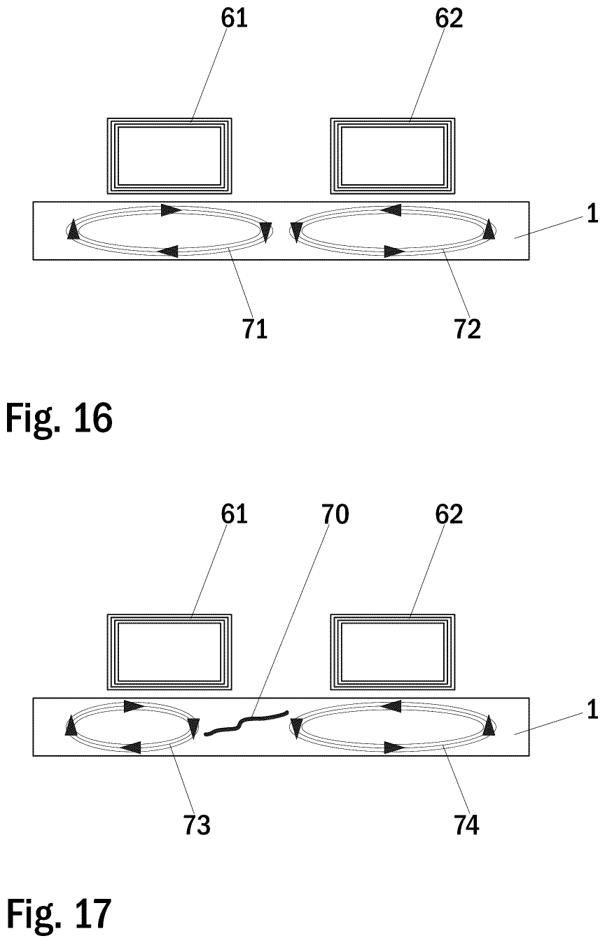

FIG. 16 illustrates a principle of an eddy current test unit coils used for condition monitoring of a rope of a hoisting apparatus according to an embodiment of the present invention. In the embodiment presented in FIG. 16, a printed circuit board comprises two excitation/sensing coils/filaments 61, 62 arranged apart from each other, wherein said printed circuit board is arranged in an upright position, i.e. in a perpendicular direction in relation to the plane formed by adjacent load bearing members of a monitored rope 1. Furthermore, said printed circuit board comprising said two excitation/sensing coils/filaments 61, 62 is placed near said monitored rope 1 and arranged in a parallel direction in relation to the length of said monitored rope 1. Likewise, said printed circuit board comprising said two excitation/sensing coils/filaments 61, 62 is also placed near one load bearing member and arranged in a perpendicular direction in relation to the width said respective load bearing member and arranged in a parallel direction in relation to the length of said respective load bearing member.

In the embodiment presented in FIG. 16, said excitation/sensing coils/filaments 61, 62 are arranged in said printed circuit board so that they are near said monitored rope 1 and near said load bearing member. Furthermore, said excitation/sensing coils/filaments 61, 62 are arranged in an upright position, i.e. in a perpendicular direction in relation to the plane formed by adjacent load bearing members of a monitored rope 1. Furthermore, said excitation/sensing coils/filaments 61, 62 are arranged in a perpendicular direction in relation to the width said respective load bearing member and arranged in a parallel direction in relation to the length of said respective load bearing member.

In the embodiment presented in FIG. 16, the excitation/sensing coils/filaments 61, 62 arranged in said printed circuit board induce eddy current 71, 72 in the monitored rope 1 along the length of the material currently inspected in said monitored rope 1. In the presented embodiment, the windings of said excitation/sensing coils/filaments 61, 62 closer to the inspection surface of said monitored rope 1 are arranged as a mirror image from one another. Both of said excitation/sensing coils/filaments 61, 62 induce an eddy current in the monitored rope 1 said eddy currents circulating in opposite directions. In FIG. 16, the excitation/sensing coil/filament 61 induces an eddy current 71 circulating in clockwise direction in the monitored rope 1 and the excitation/sensing coil/filament 62 induces an eddy current 72 circulating in counterclockwise direction in the monitored rope 1. This will force the flow of eddy current 71, 72 to descent in the perpendicular direction of the material surface between said excitation/sensing coils/filaments 61, 62.

The excitation/sensing coils/filaments 61, 62 are also used for measuring said induced eddy current 71, 72 in said monitored rope 1. The eddy current 71, 72 in said monitored rope 1 measured by said excitation/sensing coils/filaments 61, 62 is used for detecting lamination defects in the monitored rope 1. In the embodiment presented in FIG. 16, the excitation/sensing coils/filaments 61, 62 arranged in said printed circuit board measure the induced eddy current 71, 72 in the monitored rope 1 and detect that there is no lamination defects or other types of defects in the monitored rope 1.

FIG. 17 illustrates a principle of an eddy current test unit coils used for condition monitoring of a defected rope of a hoisting apparatus according to an embodiment of the present invention. In the embodiment presented in FIG. 17, there is a lamination defect 70 in the monitored rope 1. The lamination defect 70 may be caused e.g. by delamination.

In the embodiment presented in FIG. 17, a printed circuit board comprises two excitation/sensing coils/filaments 61, 62 arranged apart from each other, wherein said printed circuit board is arranged in an upright position, i.e. in a perpendicular direction in relation to the plane formed by adjacent load bearing members of a monitored rope 1. Furthermore, said printed circuit board comprising said two excitation/sensing coils/filaments 61, 62 is placed near said monitored rope 1 and arranged in a parallel direction in relation to the length of said monitored rope 1. Likewise, said printed circuit board comprising said two excitation/sensing coils/filaments 61, 62 is also placed near one load bearing member and arranged in a perpendicular direction in relation to the width said respective load bearing member and arranged in a parallel direction in relation to the length of said respective load bearing member.

In the embodiment presented in FIG. 17, said excitation/sensing coils/filaments 61, 62 are arranged in said printed circuit board so that they are near said monitored rope 1 and near said load bearing member. Furthermore, said excitation/sensing coils/filaments 61, 62 are arranged in an upright position, i.e. in a perpendicular direction in relation to the plane formed by adjacent load bearing members of a monitored rope 1. Furthermore, said excitation/sensing coils/filaments 61, 62 are arranged in a perpendicular direction in relation to the width said respective load bearing member 3 and arranged in a parallel direction in relation to the length of said respective load bearing member 3.

In the embodiment presented in FIG. 17, the excitation/sensing coils/filaments 61, 62 arranged in said printed circuit board induce eddy current 73, 74 in the monitored rope 1 along the length of the material currently inspected in said monitored rope 1. Both of said excitation/sensing coils/filaments 61, 62 induce an eddy current in the monitored rope 1 with opposite signals. In FIG. 17, the excitation/sensing coil/filament 61 induces an eddy current 73 circulating in clockwise direction in the monitored rope 1 and the excitation/sensing coil/filament 62 induces an eddy current 74 circulating in counterclockwise direction in the monitored rope 1. This will force the flow of eddy current 73, 74 to descent in the perpendicular direction of the material surface between said excitation/sensing coils/filaments 61, 62. This way the eddy currents 73, 74 are forced to go through the horizontal lamination defect 70, making its detection possible.

In the embodiment presented in FIG. 17, the lamination defect in the monitored rope 1 affects the eddy current 73 circulating in clockwise direction in the monitored rope 1. The excitation/sensing coils/filaments 61, 62 are also used for measuring said induced eddy current 73, 74 in said monitored rope 1.

The eddy current 73, 74 in said monitored rope 1 measured by said excitation/sensing coils/filaments 61, 62 is used for detecting lamination defects in the monitored rope 1. In the embodiment presented in FIG. 17, the excitation/sensing coil/filament 61 measures the induced eddy current 73 in the monitored rope 1, said eddy current 73 being affected by the lamination defect in the monitored rope 1. In the embodiment presented in FIG. 17, the excitation/sensing coils/filaments 61, 62 arranged in said printed circuit board measure the induced eddy current 73, 74 in the monitored rope 1 and detect that there is a lamination defect 70 in the monitored rope 1. The excitation/sensing coils/filaments 61, 62 arranged in said printed circuit board may also detect possible other types of defects in the monitored rope 1.

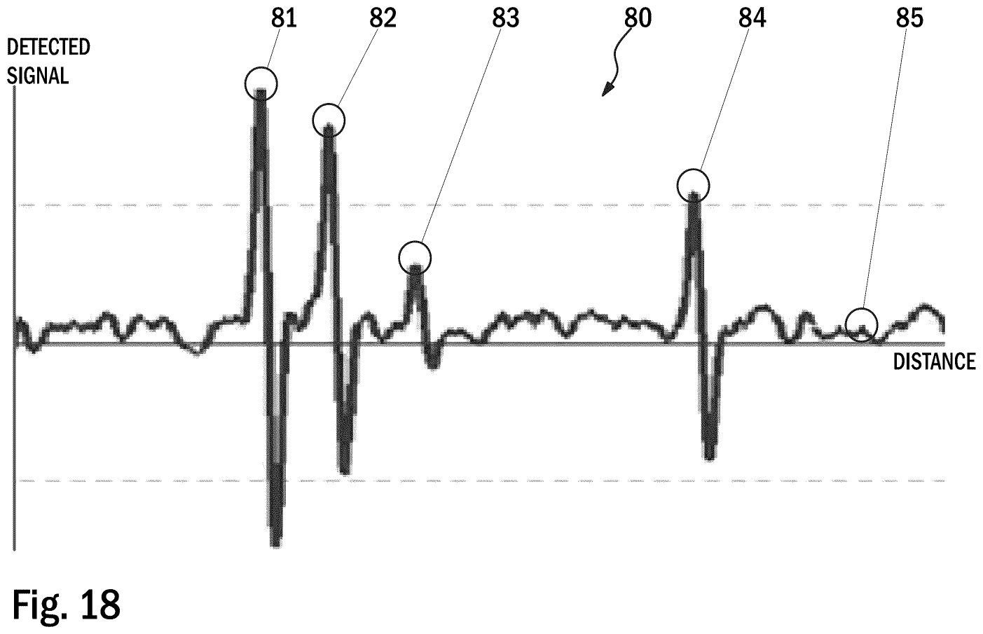

FIG. 18 illustrates an example of a detected electromagnetic signal according to one embodiment of the present invention having defects in the rope. In FIG. 18 there is illustrated an example of the change of the electromagnetic signal along longitudinal direction of the monitored rope 1, according to one embodiment of the present invention, allowing the detection of defects in the monitored rope 1, due to electromagnetic signal variations. In the example shown in FIG. 18 a defected moving rope 1 is monitored with an eddy current test unit 40, 50. In the test arrangement, a time-varying magnetic field is generated by an eddy current test unit of said eddy current test unit 40, 50 placed near moving rope 1, said time-varying magnetic field causing eddy currents in said moving rope 1. Consequently, a secondary magnetic field is generated in said moving rope 1 by said eddy currents, which secondary magnetic field is detected by said eddy current test unit of said eddy current test unit 40, 50 as an electromagnetic signal 80, i.e. as eddy current detection data 80. Said generated time-varying magnetic field may be an alternating magnetic field generated by using alternating current. Said generated time-varying magnetic field may also be a step function or any other time-varying magnetic field generated by using any other time-varying current.

In the detected electromagnetic signal 80, there can be detected unusual peaks 81-84 indicating defects in said defected moving rope 1. From the detected electromagnetic signal 80 the defect indicating peaks 81-84 can be detected and analyzed by an on-line monitoring unit of the condition monitoring arrangement according to the present invention. In the detected electromagnetic signal 80, background noise is indicated with a reference number 85.

In the condition monitoring arrangement according to the present invention an at least one eddy current test unit placed near a monitored rope 1 generates a time-varying magnetic field to said monitored rope 1. Said time-varying magnetic field causes eddy currents in said rope 1, which said eddy currents in turn generate a secondary magnetic field in said monitored rope 1. Thereafter, said at least one eddy current test unit detects said secondary magnetic field in said monitored rope 1 as eddy current detection data. After detecting, an analyzer unit of the condition monitoring arrangement analyzes the detected eddy current detection data.

The analyzer unit may or may not continue with another measurement and repeat steps of generating, detecting and analyzing. The analyzer unit may be instructed to or may be automated to carry out multiple measurements. In said multiple measurements the analyzer unit may change the generated time-varying magnetic field signal by changing e.g. signal form, signal amplitude and/or signal frequency of said generated time-varying magnetic field.

After carrying out enough measurements the analyzer unit of the condition monitoring arrangement provides one or more parameters to an on-line monitoring unit of said condition monitoring arrangement for the determination of the types of the defects and condition of the hoisting rope 1. After receiving one or more parameters for the determination of the types of the defects and condition of the hoisting rope 1 said on-line monitoring unit performs condition monitoring actions.

The condition monitoring arrangement according to the present invention can be utilized to monitor and to detect local defects in the monitored rope, slackness of the monitored rope, changes in the resistivity of the monitored rope and rope location on a pulley or on a traction sheave. With the help of the condition monitoring arrangement according to the present invention, a separate rope alignment detector may prove to be redundant.

The condition monitoring arrangement according to the present invention can detect delamination and multiple different types of defects including defects that cannot be seen visually. The movable eddy current testing device according to the present invention is portable and easy to use in periodic maintenance and diagnostic operations. No physical contact or contact fluid to the rope is needed. The eddy current test unit according to the present invention can easily be produced and is inexpensive to manufacture.

When the printed circuit boards of the eddy current test unit are arranged in a small angle, i.e. in a direction turned 20 degrees or less from the parallel direction, the eddy current test unit can inspect whole width of the load bearing members and the monitored rope.

With the help of the condition monitoring arrangement according to the present invention inspections can be performed at least at speeds up to 4 m/s and damages can be located and characterized by dimension and morphology. The condition monitoring arrangement according to the present invention can be used by maintenance personnel to assess rope condition e.g. after installation or during scheduled maintenance and help decide further actions if necessary.

The condition monitoring arrangement according to the present invention provides a new solution with a specifically designed handheld device with improved detectability of fiber cuts and new inspection probe geometry for the detection of delamination's defects. The condition monitoring arrangement can also be adapted to monitor all ropes continuously and throughout the whole length of each rope. The condition monitoring arrangement requires very little space and requires no physical contact between the inspection probes and the rope.

The condition monitoring arrangement according to the present invention can be set as a permanently installed device. The condition monitoring arrangement according to the present invention can be connected to the cloud server, where measured data can be post-processed.

When referring to conductivity, in this application it is meant electrical conductivity.

It is to be understood that the above description and the accompanying Figures are only intended to teach the best way known to the inventors to make and use the invention. It will be apparent to a person skilled in the art that the inventive concept can be implemented in various ways. The above-described embodiments of the invention may thus be modified or varied, without departing from the invention, as appreciated by those skilled in the art in light of the above teachings. It is therefore to be understood that the invention and its embodiments are not limited to the examples described above but may vary within the scope of the claims and their equivalents.

1. An arrangement for condition monitoring of a rope of a hoisting apparatus, which rope comprises a plurality of conductive load bearing members for bearing the load exerted on the rope in longitudinal direction and extending parallel to each other and to the longitudinal direction of the rope, which arrangement comprises:
one or more eddy current test units arranged for being placed near said rope for generating a time-varying magnetic field, said time-varying magnetic field causing eddy currents in said rope, and for detecting a secondary magnetic field being generated by said eddy currents in said rope as eddy current detection data, and
an on-line monitoring unit receiving and utilizing said eddy current detection data for on-line condition monitoring of said rope,
wherein an at least one eddy current test unit of said one or more eddy current test units comprises:
two or more printed circuit boards arranged for being placed near said rope and arranged in a perpendicular direction in relation to the plane formed by adjacent load bearing members of said rope and parallel to each other, and arranged in a parallel direction or in a direction turned degrees or less from the parallel direction in relation to the length of said rope,
wherein at least one printed circuit board of said one or more printed circuit boards each comprises one or more eddy current inspection probes, each of said one or more eddy current inspection probes comprising two excitation coils and/or sensing coils arranged for being near said rope in said at least one printed circuit board.

2. A condition monitoring arrangement according to claim 1, wherein said on-line monitoring unit comprises a chassis that maintains the position of said one or more eddy current test units with regard to the rope.

3. A condition monitoring arrangement according to claim 1, wherein said on-line monitoring unit is a movable eddy current testing device comprising positioning elements.

4. A condition monitoring arrangement according to claim 1, wherein said at least one eddy current test unit comprises one printed circuit board of said one or more printed circuit boards for each conductive load bearing member in said rope.

5. A condition monitoring arrangement according to claim 1, wherein said two excitation coils and/or sensing coils arranged in a perpendicular direction in relation to the plane formed by adjacent load bearing members of said rope and parallel to each other, and arranged in a parallel direction or in a direction turned 20 degrees or less from the parallel direction in relation to the length of said rope.

6. A condition monitoring arrangement according to claim 4, wherein said two excitation coils and/or sensing coils arranged near a load bearing member and in a parallel direction or in a parallel direction or in a direction turned 20 degrees or less from the parallel direction in relation to the length of said load bearing member.

7. A condition monitoring arrangement according to claim 1, wherein the windings of said two excitation coils and/or sensing coils have several turns in one or more layers.

8. A condition monitoring arrangement according to claim 1, wherein the windings of said two excitation coils and/or sensing coils closer to the inspection surface of said rope are linear.

9. A condition monitoring arrangement according to claim 1, wherein the windings of said two excitation coils and/or sensing coils closer to the inspection surface of said rope are arranged as a mirror image of one another.

10. A condition monitoring arrangement according to claim 1, wherein in said at least one printed circuit board said two excitation coils and/or sensing coils are arranged 20-100 mm apart from each other.

11. A condition monitoring arrangement according to claim 1, wherein said on-line monitoring unit is arranged to determine the condition, the position, the alignment or the tension of said rope based on said eddy current detection data.

12. A condition monitoring arrangement according to claim 1, wherein said on-line monitoring unit is arranged to determine whether there is any defect and/or damage in the rope and the location and/or position and/or type of a defect and/or damage based on said eddy current detection data.

13. A condition monitoring arrangement according to claim 1, wherein said at least one eddy current test unit is arranged for carrying out multiple measurements in detecting said eddy currents by changing signal form, signal amplitude and/or signal frequency of said generated time-varying magnetic field.

14. A condition monitoring arrangement according to claim 1, wherein said at least one eddy current test unit comprises two eddy current test units arranged on both sides of the monitored rope or around the monitored rope.

15. A condition monitoring arrangement according to claim 1, wherein said arrangement comprises a data storage for storing and retrieving said eddy current detection data.
